(19) United States
(12) Patent Application Publication
(10) Pub. No.: US 2005/0236953 A1
(43) Pub. Date: Oct. 27, 2005

(54) Field emission device (FED)

(76) Inventors: Jeong-Hee Lee, Seongnam-si (KR); Tae-Won Jeong, Seoul (KR); Won-Seok Kim, Gunsan-si (KR); Sang-Hyun Lee, Yongin-si (KR); Hyun-Jung Lee, Daejeon-si (KR); Jeong-Na Huh, Yongin-si (KR)

Correspondence Address: Robert E. Bushnell, Suite 300, 1522 K Street, N.W., Washington, DC, 20005-1202, US

(21) Appl. No.: 11/107,846

(22) Filed: Apr. 18, 2005

(30) Foreign Application Priority Data
Apr. 27, 2004 (KR) 10-2004-0029194

(51) Int. Cl. H01J 1/02

(52) U.S. Cl. 313/310

(57) ABSTRACT

A Field Emission Device (FED) includes an emitter formed on a cathode electrode and including Carbon NanoTubes (CNTs), and a gate electrode to extract electrons from the emitter. In addition, a RuOx layer or a PdOx layer is coated on the emitter to protect the CNTs and to stabilize the emission from the CNTs. A stabilizer layer to stabilize an emission structure and to protect emission ends is coated on the surface of a CNT emitter or the surfaces of the CNTs, more specifically, the emission ends of the CNTs, in order to prevent abrasion of the CNTs caused by an excess current or an emission process.

### CLAIM OF PRIORITY

This application makes reference to, incorporates the same herein, and claims all benefits accruing under 35 U.S.C. § 119 from an application entitled FIELD EMISSION DEVICE filed with the Korean Intellectual Property Office on Apr. 27, 2004, and there duly assigned Serial No. 10-2004-0029194.

### BACKGROUND OF THE INVENTION

1. Field of the Invention

The present invention relates to an Field Emission Device (FED), and more particularly, to an FED with improved emission stability and durability.

2. Description of the Related Art

A carbon NanoTube (CNT) generates field emission even at a low voltage due to a small diameter and a sharp end. U.S. Pat. No. 6,339,281 relates to a Field Emission Array (FEA) using an emitter mixed paste and a method of manufacturing the FEA. U.S. Pat. No. 6,440,761 relates to an FEA using CNTs, which are formed by a growing method, as an emitter, and a method of manufacturing the FEA. In general, it is convenient to form an emitter by using a paste compared to a growing method, and accordingly, the former method is preferred.

A conventional CNT emitter is formed either on a cathode or on a high conductivity material layer formed on the cathode.

A triode CNT FEA includes a cathode electrode formed on a substrate and a gate insulating layer formed on the cathode electrode. A through hole is formed in the gate insulating layer and a CNT emitter formed of a plurality of CNTs is arranged at the bottom of the through hole. The CNT emitter is formed on a portion of the cathode electrode that is exposed through the bottom of the through hole. A gate electrode having a gate hole that extracts electrons from the CNT emitter is formed on the gate insulating layer.

The task of a field emission display using such a CNT emitter is to improve reliability of the CNTs, that is, to stably emit electrons from the front ends of the CNTs, that is, the emission ends of the CNTs. In the CNT emitter formed by using a paste, a resistant material and a conductive material are mixed, and electrons are supplied to the emission ends of CNTs through such materials. The electrons are supplied through a number of paths, which have an excellent conductivity. Thus, an excess current flows through the paths having the excellent conductivity. Accordingly, when emitting electrons, an electrochemical potential is increased at the emission ends of the CNTs, resulting in the degradation of the emission ends of the CNTs. Although the cause of the degradation has not been clearly examined, the flow of an emission current, more specifically, the flow of the excess current, increases the temperature, to improve the reaction of a reactive material existing around the emission ends of the CNTs, for example, oxygen. As a result, the decomposition of the emission ends is promoted. Damage to the CNTs include, for example, the abrasion of the emission ends, a degradation of an image quality and a reduction of the lifespan of the field emission display.

### SUMMARY OF THE INVENTION

The present invention provides an FED that efficiently protects the emission ends of Carbon NanoTubes (CNTs) and stably emits electrons.

According to one aspect of the present invention, a Field Emission Device (FED) is provided comprises: a substrate; a cathode electrode formed on the substrate; an emitter formed on the cathode electrode and including Carbon NanoTubes (CNTs); a gate electrode adapted to extract electrons from the emitter; and a stabilizer layer arranged on the emitter and adapted to protect the CNTs and to stabilize emission from the CNTs.

The emitter preferably further comprises a conductive material.

The conductive material preferably comprises silver.

The stabilizer layer preferably has a thickness in a range of 1 to 100 nm.

The stabilizer layer preferably includes at least one of SiO₂, MgO, TiO₂, BN, RuOx, and PdOx.

According to another aspect of the present invention, a Field Emission Device (FED) comprises: a substrate; a cathode electrode arranged on the substrate; an emitter arranged on the cathode electrode and including a plurality of Carbon NanoTubes (CNTs) having emission ends; a gate electrode adapted to extract electrons from the emission ends of the CNTs; and stabilizer layers arranged on surfaces of the CNTs and adapted to protect the CNTs and stabilize emission from the CNTs.

The emitter preferably further comprises a conductive material.

The conductive material preferably comprises silver.

The stabilizer layer preferably has a thickness in a range of 1 to 100 nm.

The stabilizer layer preferably includes at least one of SiO₂, MgO, TiO₂, BN, RuOx, and PdOx.

According to yet another aspect of the present invention, a Field Emission Device (FED) comprises: a substrate; a cathode electrode arranged on the substrate; an emitter arranged on the cathode electrode and including a plurality of perpendicularly grown Carbon NanoTubes (CNTs), the CNTs having emission ends; a gate electrode adapted to extract electrons from the emission ends of the CNTs; and stabilizer layers arranged on the emission ends of the CNTs and adapted to protect the CNTs and stabilize emission from the CNTs.

The emitter preferably further comprises a conductive material.

The conductive material preferably comprises silver.

The stabilizer layer preferably has a thickness in a range of 1 to 100 nm.

The stabilizer layer preferably includes at least one of SiO₂, MgO, TiO₂, BN, RuOx, and PdOx.

### BRIEF DESCRIPTION OF THE DRAWINGS

The above and other features and advantages of the present invention will become more apparent by describing in detail exemplary embodiments thereof with reference to the attached drawings in which:

FIG. 1 is a sectional view of an FED;

FIG. 2 is a sectional view of an FED according to a first embodiment of the present invention;

FIG. 3 is a sectional view of an FED according to a second embodiment of the present invention;

FIGS. 4A and 4B are Transmission Electron Microscope (TEM) images of CNTs on which a SiO₂ stabilizer has been coated according to an embodiment of the present invention;

FIGS. 5A and 5B are TEM images of Single Walled NanoTubes (SWNTs) having a diameter of 1.37 nm on which a RuOx stabilizer has been coated according to an embodiment of the present invention;

FIGS. 6A and 6B are TEM images of Double Walled NanoTubes (DWNTs) having a diameter of 2.671 nm on which a RuOx stabilizer has been coated according to an embodiment of the present invention;

FIG. 7 is a photograph of CNT emitters having coating layers of different thicknesses, the coating layers being air fired at a temperature of 570° C. for 20 minutes;

FIG. 8 is a graph of the lifespan characteristics of an emitter on which no stabilizer has been coated thereon and an emitter on which SiO₂ has been coated according to an embodiment of the present invention;

FIG. 9 is a sectional view of an FED according to a third embodiment of the present invention;

FIG. 10 is a Scanning Electron Microscopy (SEM) images of CNTs, which are perpendicularly grown on a cathode electrode;

FIGS. 11 through 13 are SEMs images of CNTs on which a SiO₂ stabilizer has been coated by sputtering to thicknesses of about 200 Å, 500 Å, and 1,000 Å according to an embodiment of the present invention;

FIG. 14 is a graph of the relationships between current and voltage of CNTs, which are grown on a cathode electrode, and on which either a stabilizer has not been formed or a SiO₂ stabilizer has been formed to thicknesses of 50 Å, 100 Å, 200 Å, 450 Å, and 1,000 Å, respectively, according to an embodiment of the present invention;

FIG. 15 is a graph of the relationship between time and current of CNTs on which a stabilizer has not been coated;

FIGS. 16 through 18 are graphs of the relationships between time and current of CNTs on which a MgO stabilizer has been coated to thicknesses of 120 Å, 180 Å, and 400 Å, respectively, according to an embodiment of the present invention; and

FIGS. 19 through 21 are graphs of the relationships between time and current of CNTs on which a SiO₂ stabilizer has been coated to thicknesses of 200 Å, 450 Å, and 1,000 Å, respectively, according to an embodiment of the present invention.

### DETAILED DESCRIPTION OF THE INVENTION

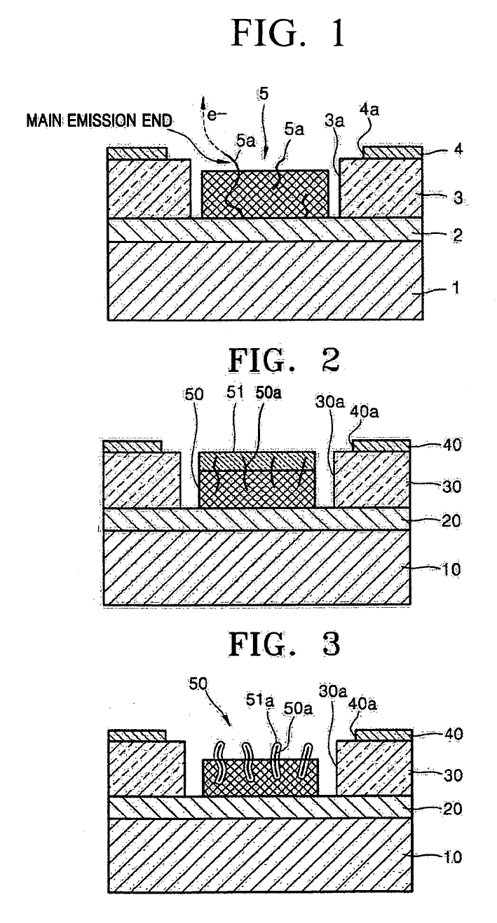

FIG. 1 is a sectional view of a triode CNT FEA.

Referring to FIG. 1, a cathode electrode 2 is formed on a substrate 1, and a gate insulating layer 3 is formed on the cathode electrode 2. A through hole 3a is formed in the gate insulating layer 3, and a CNT emitter 5 formed of a plurality of CNTs is arranged at the bottom of the through hole 3a. The CNT emitter 5 is formed on a portion of the cathode electrode 2 that is exposed through the bottom of the through hole 3a. A gate electrode 4 having a gate hole 4a that extracts electrons from the CNT emitter 5 is formed on the gate insulating layer 3.

The present invention will now be described more fully with reference to the accompanying drawings, in which exemplary embodiments of the invention are shown.

First Embodiment

Referring to FIG. 2, a cathode electrode 20 is formed on a substrate 10, and a gate insulating layer 30 is formed on the cathode electrode 20. A through hole 30a to receive a CNT emitter 50 is formed in the gate insulating layer 30, and the CNT emitter 50 to emit electrons is formed at the bottom of the through hole 30a. The CNT emitter 50 is formed on a portion of the cathode electrode 20 that is exposed through the bottom of the through hole 30a. The CNT emitter 50 includes a plurality of CNTs 50a and can further include a conductive material, for example, Ag particles, for efficiently supplying currents to the CNTs 50a.

A stabilizer layer 51 to stabilize the emission from the CNTs while protecting the CNTs is coated on the CNT emitter 50. The stabilizer layer 51 permits the emission of electrons from the CNTs 50a and covers the CNTs 50a on the surface of the CNT emitter 50. An example of the stabilizer layer 51 includes any one material or a mixture of at least two materials selected from the group formed of SiO₂, MgO, TiO₂, BN, RuOx, and PdOx. In addition, the stabilizer layer 51 is formed to a thickness of 1 to 100 nm in order to permit the emission of electrons.

On the other hand, a gate electrode 40 having a gate hole 40a to extract electrons from the CNT emitter 50 is formed on the gate insulating layer 30.

In the first embodiment of the present invention, the CNT emitter 50 is formed by screen printing or spin coating and lifting off by using a CNT paste. The stabilizer layer 51 of the CNT emitter 50 can be formed by screen printing using a stabilizer paste, a spin coating of sol-gel method, sputtering, or evaporation.

Second Embodiment

Referring to FIG. 3, a cathode electrode 20 is formed on a substrate 10, and a gate insulating layer 30 is formed on the cathode electrode 20. A through hole 30a to receive a CNT emitter 50 is formed in the gate insulating layer 30, and the CNT emitter 50 to emit electrons is formed at the bottom of the through hole 30a. The CNT emitter 50 is formed on a portion of the cathode electrode 20 that is exposed through the bottom of the through hole 30a. The CNT emitter 50 includes a plurality of CNTs 50a and can further include a conductive material, for example, Ag particles, for efficiently supplying currents to the CNTs 50a.

Stabilizer layers 51a for stabilizing the emission from the CNTs 50a are coated on the surfaces of the CNTs 50a. Examples of the stabilizer layers 51 a include SiO₂, MgO, TiO₂, BN, RuOx, and PdOx. In addition, the stabilizer layer 51a is formed to a thickness of 1 to 100 nm in order to permit the emission of electrons.

On the other hand, a gate electrode 40 having a gate hole 40a to extract electrons from the CNT emitter 50 is formed on the gate insulating layer 30.

In the second embodiment of the present invention, the CNT emitter 50 is formed by screen printing or spin coating and lifting off by using a CNT paste.

The method of manufacturing the CNTs 50a, in other words, the CNTs 50a on which the stabilizer layers 51a are coated, can vary.

An example of the method is forming stabilizer layers 51a on the surfaces of CNTs 50a by a sol-gel method. According to the sol-gel method, a CNT powder is added to a solution including a stabilizer or a stabilizer electrode. Thus, the stabilizer is coated on the surface of the CNT in a slurry state.

Other examples of the method are described below in detail.

A Method of Coating SiO₂ on CNTs

1. A TetraEthyl OrthoSilicate (TEOS) or silicon n-butoxide solution is added to a CNT powder synthesized by a predetermined method, for example, a high pressure CVD, in other words, a High Pressure Carbon monoxide (HiPCO) process, such as, a predetermined amount of Single Walled NanoTubes (SWNTs) having a diameter of about 1 nm. The weight ratio of the CNT powder and the solution is 1:10. In addition, the mixture is agitated while adding H₂O to the same weight as the CNT.

2. The mixture is dried at a temperature of 60 to 90° C. for one day, and fired in the air at a temperature of 200 to 300° C. for one to five days.

A Method of Coating MgO on CNTs

1. An Mg methoxide solution is added to the above described CNT power. The weight ratio of the CNT powder and the solution is 1:10. In addition, the mixture is properly agitated.

2. The mixture is dried at a temperature of 60 to 90° C. for one day, and fired in the air at a temperature of 200 to 300° C. for one to five days.

A Method of Coating TiO₂ on CNTs

1. A Ti n-butoxide solution is added to the above described CNT powder. The weight ratio of the CNT powder and the solution is 1:10. In addition, the mixture is agitated while adding H₂O to the same weight as the CNT.

2. The mixture is dried at a temperature of 60 to 90° C. for one day, and fired in the air at a temperature of 200 to 300° C. for one to five days.

A Method of Coating RuOx on CNTs

1. A solution, which is formed of acetone saturated with Ru pentanedionate, is added to the above described CNT powder. The weight ratio of the CNT powder and the solution is 1:10. In addition, the mixture is agitated.

2. The mixture is dried at a temperature of 60 to 90° C. for one day, and fired in the air at a temperature of 200 to 300° C. for one to five days.

A Method of Coating PdOx on CNTs

1. A solution, which is formed of acetone saturated with Pd acetate, is added to the above described CNT powder. The weight ratio of the CNT powder and the solution is 1:10 to 1:20. In addition, the mixture is properly agitated.

2. The mixture is dried at a temperature of 60 to 90° C. for one day, and fired in the air at a temperature of 200 to 300° C. for one to five days.

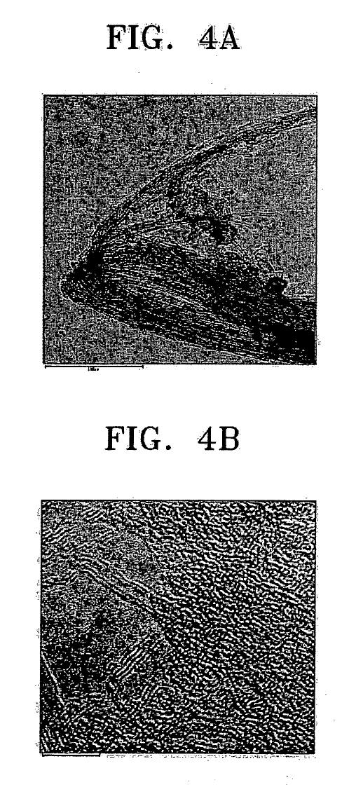

FIG. 4A is a Transmission Electron Microscope (TEM) image of CNTs on which a SiO₂ stabilizer is coated, and FIG. 4B is an enlarged TEM image of the CNTs. When the CNTs on which the SiO₂ stabilizer is coated are examined using Energy Dispersive X-ray spectroscopy (EDX), it is determined that silicon exists on the surfaces of the CNTs.

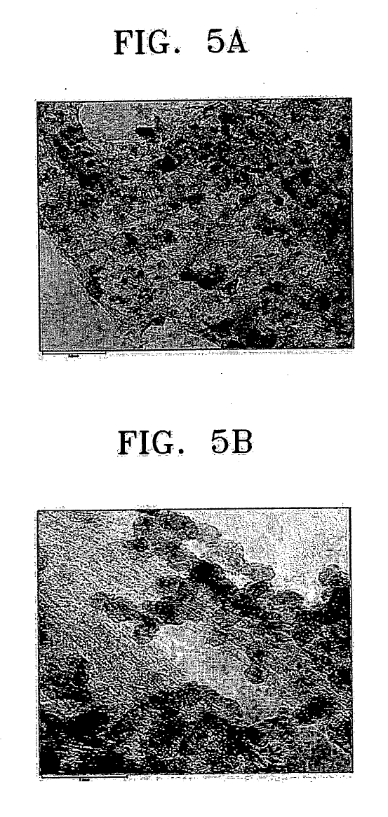

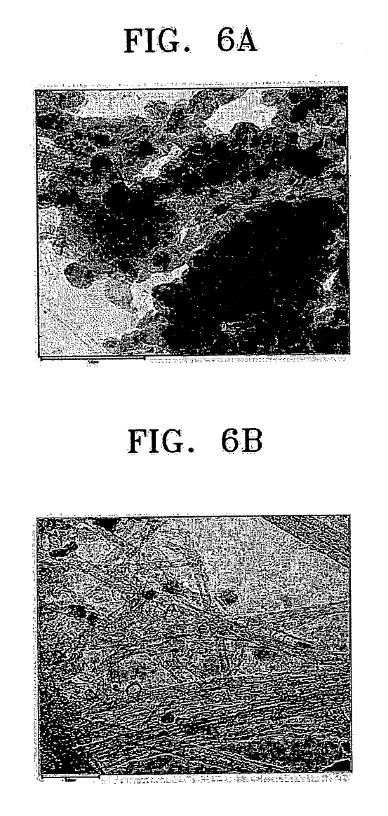

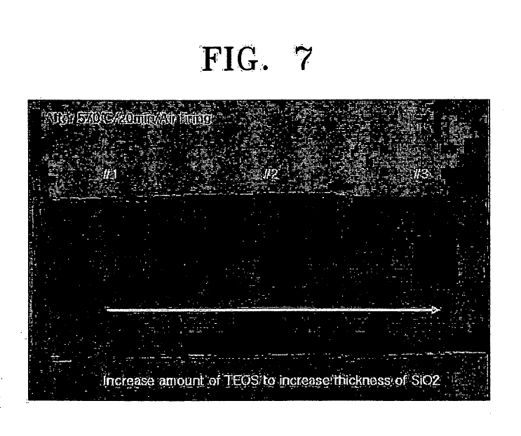

FIGS. 5A and 5B are TEM images of Single Walled NanoTubes (SWNTs) having a diameter of 1.37 nm and coated by a RuOx stabilizer. FIGS. 6A and 6B are TEM images of Double Walled NanoTubes (DWNTs) having a diameter of 2.671 nm and coated by a RuOx stabilizer. In the case of the SWNTs, the size of RuOx particles is small and the RuOx particles are evenly distributed. However, in the case of the DWNTs, the RuOx particles are lumped together.

When the stability of the CNTs, which are coated by a stabilizer, against the heat generated in manufacturing processes is examined, it is determined that the stability is better as the thickness of the stabilizer is increased. FIG. 7 is a Scanning Electron Microscopy (SEM) photograph illustrating CNT emitters having coating layers of different thicknesses and air fired at a temperature of 570° C. for 20 minutes. The thicknesses of the coating layers on the CNT emitters of FIG. 7 are arranged as #1<#2<#3. The remainder rate of CNTs on the CNT emitters is the largest in the CNT emitter #3, which is coated by the coating layer having the largest thickness.

Table 1 illustrates the result of a remainder rate examination of CNTs on CNT emitters.

TABLE 1

| sample | coating | current density | | remainder |
|---|---|---|---|---|
| No. | material | μA/cm² @ 5 V/μm | firing condition | rate (%) |
| 1 | SiO₂ | 600 | air 370° C./30 min | 37 |
| 2 | SiO₂ | 142 | X | 0 |
| 3 | SiO₂ | 142 | air 570° C./20 min | 29 |
| 4 | SiO₂ | 227 | air 570° C./20 min | 35 |
| 5 | SiO₂ | 194 | air 370° C./30 min | 52 |
| 6 | MgO | 200 | air 370° C./30 min | 35 |

Based on the result of the examination, as the thickness of the coating material is increased, the remainder rate of the CNTs is increased but the current density is decreased. The same result can be examined in the examinations using the above described coating materials.

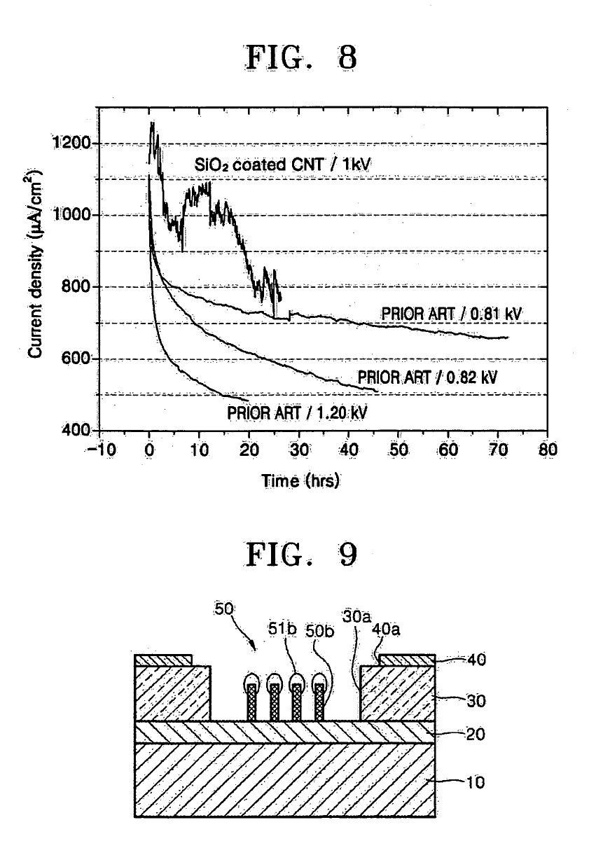

FIG. 8 is a graph illustrating the lifespan characteristics of an emitter on which a stabilizer is not coated and an emitter on which a SiO₂ stabilizer is coated according to the present invention. Based on the graph of FIG. 8, the decrease in the current density on the conventional emitter is sudden compared to the decrease in the current density on the emitter according to the present invention. In addition, the current density on the emitter according to the present invention is high and stable for a long time compared to the conventional emitter.

Third Embodiment

Referring to 9, a cathode electrode 20 is formed on a substrate 10, and a gate insulating layer 30 is formed on the cathode electrode 20. A through hole 30a to receive a CNT emitter 50 is formed in the gate insulating layer 30, and the CNT emitter 50 to emit electrons is formed at the bottom of the through hole 30a. The CNT emitter 50 is formed on a portion of the cathode electrode 20 that is exposed through the bottom of the through hole 30a. The CNT emitter 50 includes a plurality of CNTs 50b that are grown on the cathode electrode 20.

Stabilizer layers 51b for stabilizing the emission from the CNTs 50b are coated on the upper ends of the CNTs 50b, which are perpendicularly grown on the cathode electrode 20, in other words, the emission ends of the CNTs 50b. An example of the stabilizer layer 51b includes any one material or a mixture of at least two materials selected from a group formed of SiO₂, MgO, TiO₂, BN, RuOx, and PdOx. In addition, the stabilizer layer 51b is formed to a thickness of 1 to 100 nm in order to permit the emission of electrons. In FIG. 9, the stabilizer layers 51b formed at the emission ends of the CNTs 50b are exaggerated for clarity.

On the other hand, a gate electrode 40 having a gate hole 40a to extract electrons from the CNT emitter 50 is formed on the gate insulating layer 30.

In the third embodiment of the present invention, the CNTs 50b of the CNT emitter 50 are formed by a general growing method, and the stabilizer layers 51b are formed by sputtering or deposition on the surfaces of the CNTs 50b. The stabilizer layers 51b can be formed at the emission ends of the CNTs 50b by sputtering or deposition.

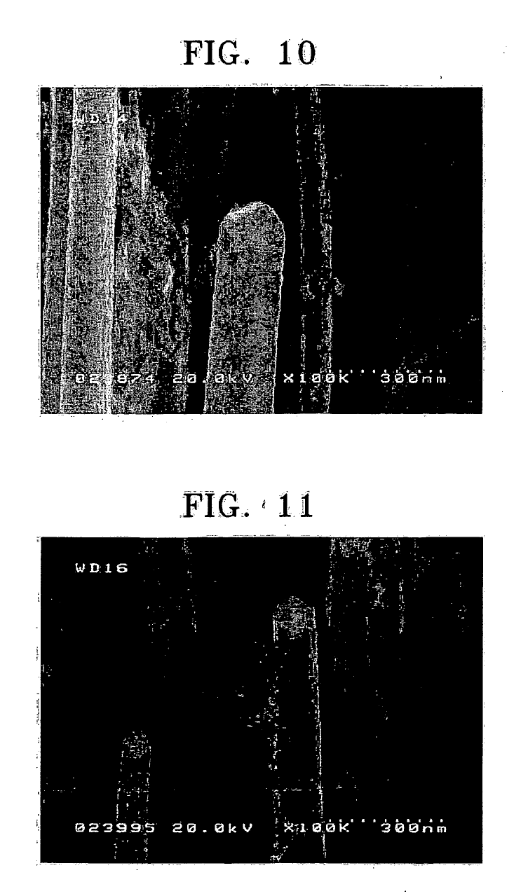

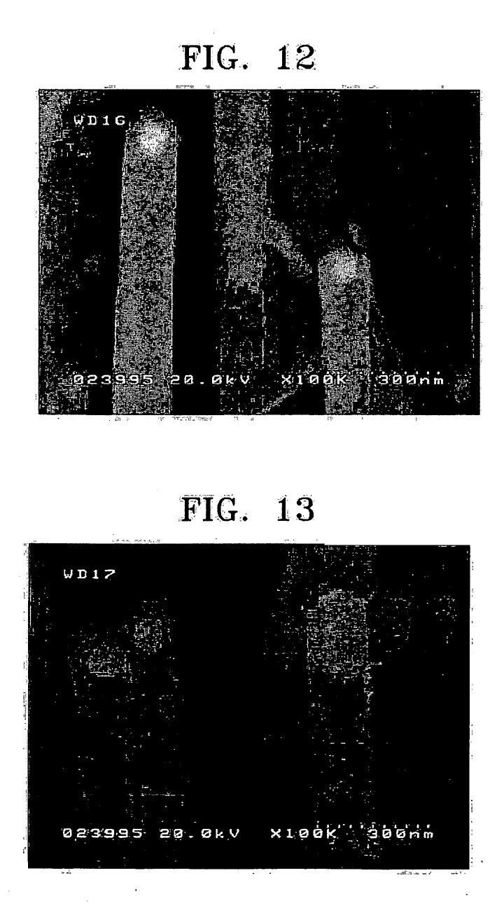

FIG. 10 is an SEM of CNTs, which are perpendicularly grown on a cathode electrode, and FIGS. 11 through 13 are SEMs of CNTs on which SiO₂ stabilizers have been coated by sputtering to thicknesses of about 200 Å, 500 Å, and 1,000 Å, respectively.

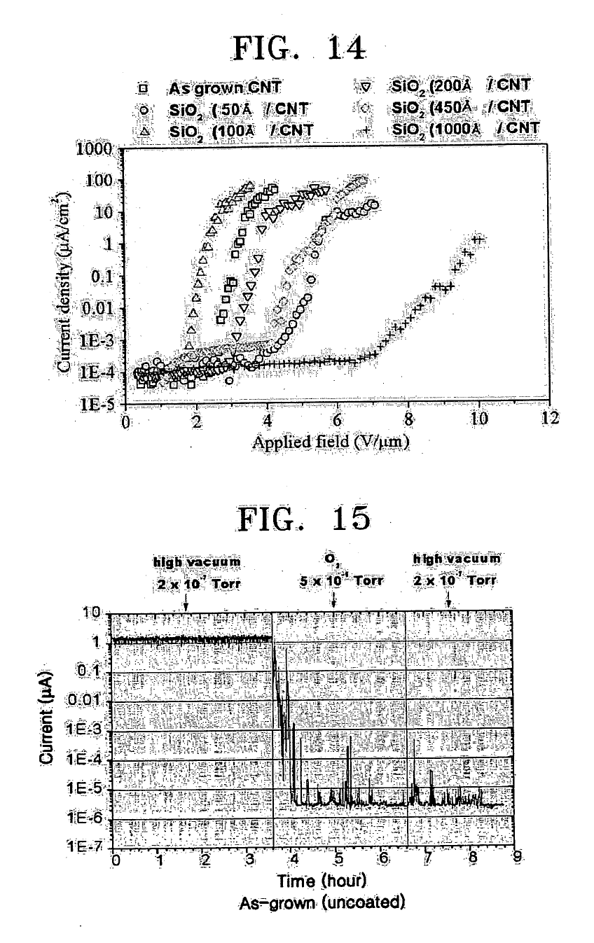

FIG. 14 is a graph illustrating the relationships between current and voltage of CNTs on which a stabilizer layer has not been formed and CNTs on which SiO₂ stabilizer layers have been coated to thicknesses of 50 Å, 100 Å, 200 Å, 450 Å, and 1,000 Å, respectively.

Based on the graph of FIG. 14, a turn-on field of the CNTs having the stabilizer layer is higher than a turn-on field of the CNTs without a stabilizer layer, when the thickness of the SiO₂ stabilizer layer is very small, for example, 50 Å, or larger than 200 Å. In addition, the turn-on field is increased as the thickness of the stabilizer layer is increased. However, a field emission characteristic is excellent when the SiO₂ stabilizer layer having a thickness of 100 Å is coated on the CNTs, and the turn-on field of the CNTs with the SiO₂ stabilizer layer having the thickness of 100 Å is smaller than the turn-on field of the CNTs without a stabilizer layer. Thus, an optimum thickness of a stabilizer layer in the examination of the present invention can be determined to be 100 Å.

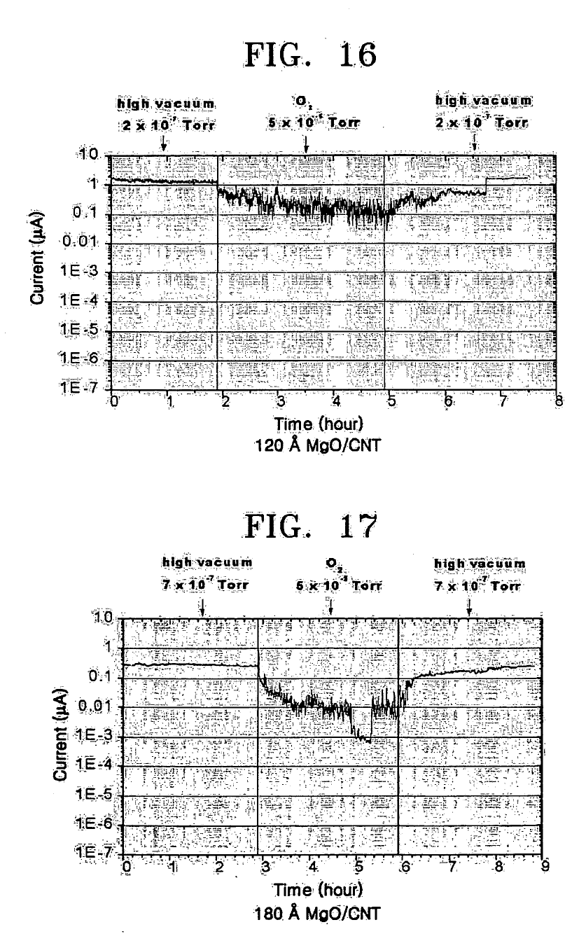

FIGS. 15 through 18 are graphs of the relationships between time and current of CNTs. The graph of FIG. 15 illustrates the relationship between time and current of CNTs on which a stabilizer has not been coated. FIGS. 16 through 18 are graphs of the relationships between time and current of CNTs on which MgO stabilizer layers have been coated to thicknesses of 120 Å, 180 Å, and 400 Å, respectively. In addition, FIGS. 19 through 21 are graphs illustrating the relationships between time and current of CNTs on which SiO₂ stabilizer layers have been coated to thicknesses of 200 Å, 450 Å, and 1,000 Å, respectively.

The graphs are formed by measuring changes in emission currents of the CNTs when a measuring atmosphere is changed from a high vacuum state to a state where blowing a small amount of oxygen, and to the high vacuum state again. Referring to the graph of FIG. 15, the emission current from the CNTs on which a stabilizer layer is not coated is reduced in an oxygen atmosphere, and the emission current is not increased even under a high vacuum state. Referring to the graphs of FIGS. 16 and 17 where the MgO stabilizer layers are coated on the CNTs to thicknesses of 120 Å and 180 Å or referring to the graph of FIG. 19 where the SiO₂ stabilizer layer is coated on the CNTs to a thickness of 200 Å, the emission currents from the CNTs are reduced in the oxygen atmosphere; however, the emission currents are increased to the original state of the high vacuum state.

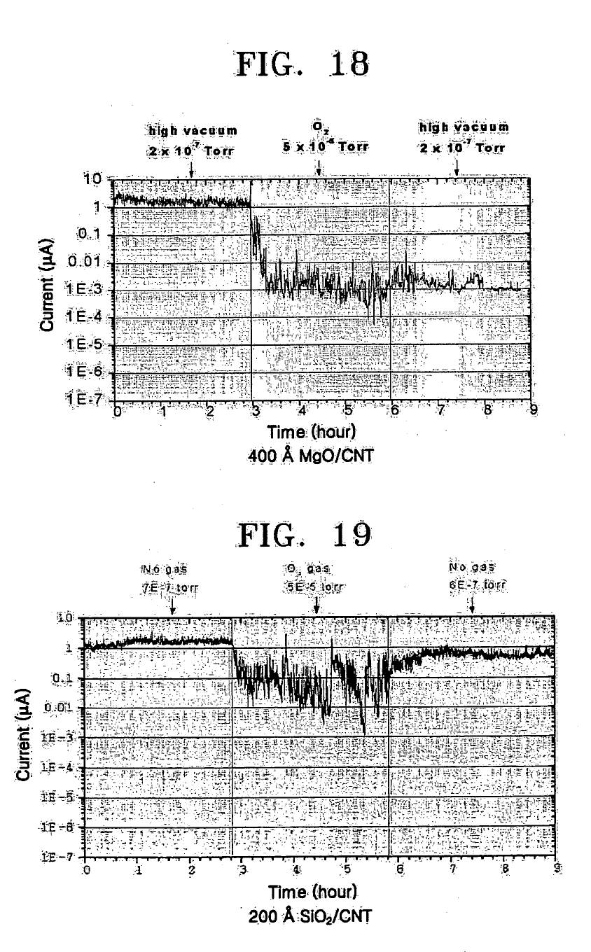

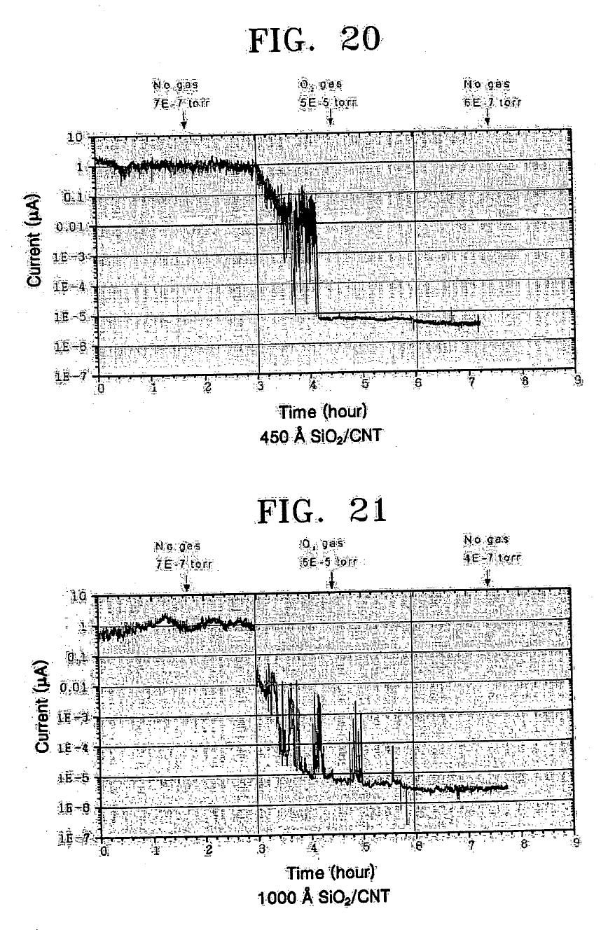

However, when the MgO stabilizer layer is coated on the CNTs to a thickness of 400 Å as shown in the graph of FIG. 18, or when the SiO₂ stabilizer layers are coated on the CNTs to a thickness of larger than 450 Å as shown in FIGS. 20 and 21, the emission currents from the CNTs are reduced in the oxygen atmosphere, and the emission currents are not increased even under the high vacuum state. When a stabilizer layer is coated on the CNTs to a thickness of larger than 400 Å, the emission current is not increased under the high vacuum state, because the stabilizer layer is damaged by a high voltage. In other words, when the thickness of the stabilizer layer is larger than a predetermined thickness, for example, about 400 Å, a voltage of over 5 V/μm must be applied in order to obtain the initial current of 1 uA as shown in FIGS. 10 through 16. In this case, the voltage can induce the breakdown of the stabilizer layer.

Accordingly, the coating of a stabilizer layer largely affects an emission current. In addition, an optimum thickness of the stabilizer layer exists to protect a material emitting electrons from the oxygen atmosphere. It is expected that the optimum thickness of the stabilizer layer according to the present invention is less than 1,000 Å, more specifically, between 100 Å and 200 Å.

According to the present invention, a stabilizer for stabilizing an emission structure and protecting emission ends is coated on the surface of a CNT emitter or the surfaces of CNTs as a main component of the CNT emitter, more specifically, on the emission ends of the CNTs. Thus, an excess current or the degradation of the CNTs in an emission process can be reduced, resulting in the increase of the lifespan of the CNTs. The stabilization and the increase of the lifespan of the CNTs can improve reliability on an FED and the value of an FED.

An FED according to the present invention can be applied to an emission source, for example, a field emission display. While the present invention has been particularly shown and described with reference to exemplary embodiments thereof, it will be understood by those of ordinary skill in the art that various modifications in form and detail can be made therein without departing from the spirit and scope of the present invention as defined by the following claims.

1. A Field Emission Device (FED) comprising:
a substrate;
a cathode electrode formed on the substrate;
an emitter formed on the cathode electrode and including Carbon NanoTubes (CNTs);
a gate electrode adapted to extract electrons from the emitter; and
a stabilizer layer arranged on the emitter and adapted to protect the CNTs and to stabilize emission from the CNTs.

2. The FED of claim 1, wherein the emitter further comprises a conductive material.

3. The FED of claim 2, wherein the conductive material comprises silver.

4. The FED of claim 1, wherein the stabilizer layer has a thickness in a range of 1 to 100 nm.

5. The FED of claim 2, wherein the stabilizer layer has a thickness in a range of 1 to 100 nm.

6. The FED of claim 3, wherein the stabilizer layer has a thickness in a range of 1 to 100 nm.

7. The FED of claim 1, wherein the stabilizer layer includes at least one of SiO₂, MgO, TiO₂, BN, RuOx, and PdOx.

8. The FED of claim 2, wherein the stabilizer layer includes at least one of SiO₂, MgO, TiO₂, BN, RuOx, and PdOx.

9. The FED of claim 3, wherein the stabilizer layer includes at least one of SiO₂, MgO, TiO₂, BN, RuOx, and PdOx.

10. A Field Emission Device (FED) comprising:
a substrate;
a cathode electrode arranged on the substrate;
an emitter arranged on the cathode electrode and including a plurality of Carbon NanoTubes (CNTs) having emission ends;
a gate electrode adapted to extract electrons from the emission ends of the CNTs; and
stabilizer layers arranged on surfaces of the CNTs and adapted to protect the CNTs and stabilize emission from the CNTs.

11. The FED of claim 10, wherein the emitter further comprises a conductive material.

12. The FED of claim 11, wherein the conductive material comprises silver.

13. The FED of claim 10, wherein the stabilizer layer has a thickness in a range of 1 to 100 nm.

14. The FED of claim 11, wherein the stabilizer layer has a thickness in a range of 1 to 100 nm.

15. The FED of claim 12, wherein the stabilizer layer has a thickness in a range of 1 to 100 nm.

16. The FED of claim 10, wherein the stabilizer layer includes at least one of SiO₂, MgO, TiO₂, BN, RuOx, and PdOx.

17. The FED of claim 11, wherein the stabilizer layer includes at least one of SiO₂, MgO, TiO₂, BN, RuOx, and PdOx.

18. The FED of claim 12, wherein the stabilizer layer includes at least one of SiO₂, MgO, TiO₂, BN, RuOx, and PdOx.

19. A Field Emission Device (FED) comprising:
a substrate;
a cathode electrode arranged on the substrate;
an emitter arranged on the cathode electrode and including a plurality of perpendicularly grown Carbon NanoTubes (CNTs), the CNTs having emission ends;
a gate electrode adapted to extract electrons from the emission ends of the CNTs; and
stabilizer layers arranged on the emission ends of the CNTs and adapted to protect the CNTs and stabilize emission from the CNTs.

20. The FED of claim 19, wherein the emitter further comprises a conductive material.

21. The FED of claim 20, wherein the conductive material comprises silver.

22. The FED of claim 20, wherein the stabilizer layer has a thickness in a range of 1 to 100 nm.

23. The FED of claim 20, wherein the stabilizer layer has a thickness in a range of 1 to 100 nm.

24. The FED of claim 21, wherein the stabilizer layer has a thickness in a range of 1 to 100 nm.

25. The FED of claim 19, wherein the stabilizer layer includes at least one of SiO₂, MgO, TiO₂, BN, RuOx, and PdOx.

26. The FED of claim 20, wherein the stabilizer layer includes at least one of SiO₂, MgO, TiO₂, BN, RuOx, and PdOx.

27. The FED of claim 21, wherein the stabilizer layer includes at least one of SiO₂, MgO, TiO₂, BN, RuOx, and PdOx.
